(19) United States
(12) Patent Application Publication
(10) Pub. No.: US 2026/0301065 A1
(43) Pub. Date: Oct. 1, 2026

(54) AUTOMATED FINANCIAL TRANSACTION VERIFICATION AND RISK ASSESSMENT PLATFORM

(71) Applicant: Gerald M. Green, Long Valley, NJ (US)

(72) Inventor: Gerald M. Green, Long Valley, NJ (US)

(21) Appl. No.: 19/630,044

(22) Filed: Mar. 26, 2026

Related U.S. Application Data
(60) Provisional application No. 63/778,718, filed on Mar. 27, 2025.
(60) Provisional application No. 63/859,250, filed on Aug. 7, 2025.

(51) Int. Cl. G06Q 40/03

(52) U.S. Cl. CPC G06Q 40/0325

(57) ABSTRACT

A computer-implemented financial data verification and evidence reconciliation system operable as a domain-agnostic, independent trust layer for downstream financial decision-making systems. The system ingests applicant data from a plurality of heterogeneous, authoritative sources with varying degrees of trust, transforms the data through canonical normalization into structured, schema-conforming data objects with preserved source provenance, detects and adjudicates cross-source discrepancies through threshold-based rules and severity classification, assigns quantifiable multi-factor confidence scores to each data element and to an aggregate applicant reliability index, and generates structured, machine-readable verification artifacts consumable by downstream systems via API or human-reviewable dashboards. The system is applicable across any domain requiring validated financial data, including but not limited to mortgage loan underwriting, credit assessment, insurance underwriting, commercial lending, and risk evaluation platforms. Mortgage loan processing is described herein as a primary illustrative embodiment.

### FIELD OF THE INVENTION

A computer-implemented financial data verification and evidence reconciliation system operable as a domain-agnostic, independent trust layer for downstream financial decision-making systems. The system ingests applicant data from a plurality of heterogeneous, authoritative sources with varying degrees of trust, transforms the data through canonical normalization into structured, schema-conforming data objects with preserved source provenance, detects and adjudicates cross-source discrepancies through threshold-based rules and severity classification, assigns quantifiable multi-factor confidence scores to each data element and to an aggregate applicant reliability index, and generates structured, machine-readable verification artifacts consumable by downstream systems via API or human-reviewable dashboards. The system is applicable across any domain requiring validated financial data, including but not limited to mortgage loan underwriting, credit assessment, insurance underwriting, commercial lending, and risk evaluation platforms. Mortgage loan processing is described herein as a primary illustrative embodiment.

### PRIOR FILINGS

This application claims priority to Provisional U.S. patent application Ser. No. 63/859,250, filed on Aug. 7, 2025, and Provisional U.S. patent application Ser. No. 63/778,718, filed on Mar. 27, 2025, both of which are incorporated herein as if fully set forth.

### BACKGROUND

A fundamental challenge across financial services is the reliable verification of applicant-supplied financial data against multiple independent authoritative sources. In domains including consumer and commercial lending, insurance underwriting, credit decisioning, and account opening, decision-makers depend on the accuracy of applicant-represented financial information, yet no systematic technical framework exists for reconciling that information across heterogeneous sources, detecting discrepancies, and producing a structured, trusted output for downstream decision systems. This verification gap creates inefficiencies, elevates fraud risk, and forces reliance on manual processes that are slow, error-prone, and difficult to audit. Within the mortgage loan industry, these challenges are particularly acute. For example, traditional mortgage verification processes are inefficient, manual, relying on disjointed document verification procedures leading to vulnerability and fraud and mistake. Existing methods rely on outdated document verification, credit checks, and risk assessment techniques, leading to delays, increased operational costs, and a higher likelihood of errors. Moreover, certain lenders enter into broker relationships wherein one party initiates the loan process and then lenders underwrite and buy the loans where the original loan company has contractual relationships wherein they must buy back the loan under certain circumstances, such as later detected fraud. It would be advantageous to incorporate an insurance component wherein an Artificial Intelligence enabled insurance wrapper guarantees the accuracy of the loan documentation used in the underwriting and loan initiation process and pays out a predetermined amount for later discovered fraud obviating the need for the loan buy-back process. Mortgage loan processing is described herein as a primary illustrative embodiment of the broader verification and reconciliation system disclosed.

A fundamental challenge in financial decision-making is the reconciliation of conflicting data about borrowers across multiple independent sources especially where those source have various degrees of trustworthiness and propensity for fraud. When a lender seeks to verify a borrower's income, for example, the borrower-reported application data may differ from payroll provider records, which may differ from bank transaction histories, which may differ from tax transcripts. Each source has different authority, recency, formatting conventions, and reliability characteristics. Existing verification systems typically treat each source in isolation or rely on manual review to reconcile discrepancies. There exists no unified technical framework that systematically normalizes heterogeneous financial data into canonical formats, tracks the provenance and authority of each data element, automatically detects and adjudicates cross-source conflicts, assigns quantifiable confidence measures based on the evidence set, and produces structured verification artifacts with full audit trails. This verification gap creates inefficiencies, increases fraud risk, and prevents automated systems from making reliable decisions based on conflicting evidence.

Computers and Artificial Intelligence (“AI”) utilizing predictive and generative algorithms have greatly enhanced countless process flows to reduce errors and speed up outcomes in many areas. Character recognition software can process documents and understand and format the information contained therein. However, there is no existing platform or system that has yet been developed to combine cross platform technologies in a way that could initially, provide a unified evidence reconciliation framework that, normalizes data from heterogenous sources into canonical schemas, maintain source lineage, detect and resolve discrepancies, generate confidence scores for the foregoing, and then be able to automate all of the process, procedure, information, and documentation lenders and the legal framework require in the loan approval process and then be able to, without additional human intervention, assess risk, identify missing or incorrect or fraudulent information, request corrective actions, and deny or approve a loan and then prepare the closing package for a lender. Thus, while AI and automation have enhanced various financial sectors and individual tasks, there exists no unified system that dynamically integrates all necessary processes—credit assessment, risk modeling, real-time data validation, and compliance enforcement—into a seamless, fully automated pipeline that autonomously processes, verifies, approves, and finalizes loans. This reconciliation gap is the central technical problem addressed by the present disclosure. The absence of such a framework means that every domain relying on financial data verification —including mortgage lending, insurance underwriting, commercial credit, and account opening —must either rely on manual review to reconcile conflicting data across independent sources, or accept verification artifacts of unknown or unquantified reliability. No existing system systematically normalizes heterogeneous financial data into canonical formats, tracks the provenance and authority of each data element, automatically detects and adjudicates cross-source conflicts, assigns quantifiable confidence measures based on the evidence set, and produces structured verification artifacts with full audit trails. In the context of mortgage lending specifically —which serves as the primary illustrative embodiment herein —this gap further prevents fully automated end-to-end processing, including risk assessment, identification of missing, incorrect, or fraudulent information, and preparation of closing documentation without additional human intervention.

The present disclosure addresses these challenges through a novel financial data verification and evidence reconciliation architecture. At its core, the system operates as an independent trust and verification layer that sits upstream of underwriting and decision-making systems. The system receives borrower financial data from multiple authoritative sources—including credit bureaus, payroll APIs, banking transaction systems, tax authorities, and document repositories—each with different data formats, field nomenclatures, and reliability characteristics. A canonical normalization engine transforms this heterogeneous input data into standardized, schema-conforming data objects while preserving source provenance and metadata. A multi-factor confidence scoring algorithm evaluates each data element based on source authority, cross-source consistency, temporal stability, and fraud indicators, generating quantifiable reliability scores. A discrepancy detection and adjudication engine identifies material inconsistencies across sources, applies threshold-based rules to classify severity, and automatically reconciles conflicts based on source hierarchy and evidence weight. The system outputs structured verification reports and machine-readable verification artifacts that downstream systems—including loan origination platforms, underwriting engines, and risk assessment tools—can consume via APIs or human-reviewable dashboards. This architecture enables the system to function not merely as a mortgage workflow tool, but as a generalizable financial evidence reconciliation framework applicable across lending, insurance, credit decisioning, and other domains requiring validated financial data.

The technology described in this paper revolutionizes mortgage loan application processing implementing AI, automation, and real-time data analytics. The platform significantly enhances verification accuracy, reduces human intervention, and strengthens fraud detection mechanisms using advanced machine learning and anomaly detection models. By integrating with major credit bureaus and financial institutions, the platform disclosed herein ensures a seamless, efficient, and secure mortgage approval process that is scalable and compliant with regulatory requirements. The disclosed system describes many embodiments that redefine mortgage loan origination by integrating advanced and tailored AI, real-time data analytics, and compliance automation, ensuring unprecedented efficiency, accuracy, and fraud prevention. This solution harmonizes borrower authentication, underwriting, and risk analysis into a singular, intelligent decision-making framework. While optical character recognition, natural language processing, and credit scoring systems have advanced significantly, no existing system provides a unified technical framework for reconciling conflicting financial evidence across authoritative sources. Existing verification services typically operate in isolation. For example, employment verification platforms verify employment and income from payroll providers; banking connectivity platforms provide access to transaction data; credit bureaus provide credit histories. Each source provides data in its own format with its own reliability characteristics, but no system systematically normalizes these disparate sources into canonical schemas, tracks provenance, detects cross-source discrepancies, adjudicates conflicts based on source authority and evidence weight, and produces a unified verification artifact with quantifiable confidence measures. This gap creates a critical vulnerability in financial decision-making. When a borrower's self-reported income differs from payroll data by a pre-determined threshold amount, or when employment dates conflict across sources, existing systems lack a systematic framework for detecting, quantifying, and resolving the discrepancy. The present invention addresses this gap through a novel, evidence-based, reconciliation architecture.

### SUMMARY

The platform described herein comprises key functionality including, real-time credit analysis: direct integration with the major credit reporting agencies such as Experian, TransUnion, and Equifax APIs for comprehensive credit evaluations; AI-Driven risk assessment: machine learning models analyze borrower eligibility based on financial stability, historical data, and predictive analytics; automated document verification: AI-enhanced optical character recognition (OCR) and anomaly detection algorithms validate authenticity; real-time banking transaction analysis: direct integration with Plaid (or other income verification service) API for income verification and financial behavior assessment; AI-Powered fraud detection: advanced algorithms detect inconsistencies, document forgery, and suspicious activity patterns; and seamless lender integration: API-driven workflows streamline document submission, tracking, and verification. All of the foregoing is designed into a holistic ecosystem that manages borrower relationships, underwriting, and approval workflows in real-time, enabling instant decision-making and streamlined processing, and legal compliance. It is contemplated that in some embodiments, the system further comprises a data normalization engine that transforms heterogeneous input data from disparate sources into standardized, schema-conforming data objects; a multi-factor, proprietarily weighted, confidence scoring algorithm that generates weighted reliability scores based on source authority, cross-source consistency, and fraud indicators; a discrepancy detector employing threshold-based rules to identify material inconsistencies; and a structured report generation system that produces standardized verification reports and interactive verification dashboards with defined data presentation architectures including cross-source match matrices, risk indicator panels, and field-level discrepancy tables. In any of the foregoing examples, a borrower may simply be an applicant applying for something disclosing data relevant to the application, but the most typical scenario is where such applicant is a borrower applying for a loan. Throughout this specification, borrower is used to represent any type of applicant applying for something wherein they or others on their behalf supply data relevant to the application.

### BRIEF DESCRIPTION OF THE DRAWINGS

FIG. 1 depicts one embodiment of an API Workflow process of the described platform.

FIG. 2 depicts one embodiment of a compliance automation workflow as described in connection with the disclosed platform.

FIG. 3 depicts one embodiment of an overall system flowchart as contemplated by the disclosed platform.

FIG. 4 depicts one embodiment of a fraud detection process flow as contemplated by the disclosed platform.

FIG. 5 depicts one embodiment of an overall system flowchart and risk assessment scoring as applied in a mortgage loan context as contemplated by the disclosed platform.

FIG. 6 depicts one embodiment of a user interface flow diagram as contemplated by the disclosed platform.

FIG. s 7 through 10 depict one embodiment of a typical scoring logic and weighted factors making up a proprietary credit score that is implemented in the disclosed platform.

FIG. 11 depicts one embodiment of a full flow diagram for the platform as disclosed herein.

FIG. 12 depicts one embodiment of a work flow diagram logic for the platform as disclosed herein.

FIG. 13 depicts one embodiment of a work flow diagram logic for an intelligent data reconciliation and risk detection engine component wherein an AI enabled insurance wrapper component provides a metric based risk score for all potential for fraud in the loan documentation and offers an insurance payout for later detected fraud.

FIG. 14 depicts one embodiment of a work flow diagram for an AI driven mortgage fraud detection using metric based risk scoring.

FIG. 15 depicts one embodiment of a diagram of a system architecture for direct desktop underwriter integration and automated loan qualification workflow.

FIG. 16 depicts one embodiment of a diagram flow chart of a method implementing verification of digital assets while maintaining privacy and security within the overall framework of the present disclosure.

FIG. 17 depicts one embodiment of a data normalization engine architecture showing heterogenous input sources flowing through the mapping layer, standardization module, entity resolution engine, and canonical schema output.

FIG. 18 depicts one embodiment of a confidence scoring algorithm flow diagram illustrating the weighted factor calculations (source authority, cross-source consistency, validation integrity, stability indicators, and fraud signals) leading to a composite reliability score and borrower reliability index.

FIG. 19 depicts one embodiment of a discrepancy detector rules engine flow showing variance-threshold detection, logical-inconsistency checks, temporal-anomaly detection, and identity-mismatch detection, along with the generation of structured discrepancy records and audit log entries.

FIG. 20 depicts one embodiment of a structured verification report architecture showing normalized data tables, cross-source match matrices, risk indicator panels, discrepancy tables, and verification metadata designed for both machine-readable and human-review formats.

FIG. 21 depicts one embodiment of a verification dashboard interface showing real-time verification status, reliability score visualization, source authority summaries, discrepancy monitoring, fraud probability indicators, and an audit trail panel.

FIG. 22 depicts one embodiment of an end-to-end verification and risk-assessment system architecture showing the full processing pipeline from borrower input and third-party data sources through ingestion, normalization, cross-source verification, scoring, discrepancy detection, fraud analysis, report generation, and underwriting decision support.

### DETAILED DESCRIPTION

For clarity of disclosure, and not by way of limitation, the detailed description of the invention is divided into the following subsections that describe or illustrate certain features, embodiments or applications of the present invention.

### Definitions

“proprietary credit score” as used herein means a proprietary AI-driven creditworthiness and risk evaluation metric that dynamically adjusts based on borrower inputs, market conditions, and integrates live DU findings and real-time verification data. Unlike static scoring models, such as FICO scores, or any ‘in-existence’ credit scoring system, the proprietary credit score here dynamically adjusts based on borrower behavior, alternative lending factors, and real-time lending criteria for continuous updates, all according to the proprietary method of weighting the individual factors as disclosed. “AILO” as used herein means a proprietary, AI enabled virtual loan officer configured to function as an interactive, real-time decision making assistant and expert loan officer that can guide the borrower and adjust loan structuring and lender recommendations dynamically based on changing financial and economic conditions as well as borrower input and a changing proprietary credit score. “intelligent rate lock advisory” as used herein means a proprietary and predictive, AI-enabled rate lock mechanism wherein a rate lock is based upon an analysis of historical market trends, Federal Reserve rate movements, and borrower profiles and input to recommend an optimal rate lock window based on AI-driven forecasts. “lender matching” as used herein means a proprietary system approach of continuous refinement of multiple lenders'loan criteria to a borrowers desired goals and approvals, all based in real-time and on continuously updated approvals, borrower qualification shifts, and adaptive risk modeling.

### The System and Method of the Present Invention

The system disclosed herein is architected at its core as a financial data evidence reconciliation and verification engine that is a domain-agnostic technical framework for ingesting applicant financial data from multiple heterogeneous, authoritative sources, normalizing that data into canonical structured formats with preserved source provenance, detecting and adjudicating cross-source discrepancies, assigning quantifiable confidence scores to each data element and to an aggregate applicant reliability index, and generating structured verification artifacts consumable by downstream decision systems. In one embodiment, this core architecture comprises a data normalization engine, a provenance and lineage tracking layer, a cross-source reconciliation and confidence scoring engine, a discrepancy detector with rules engine, and a structured verification output layer, and is the central technical innovation of the present disclosure. While the specification describes mortgage loan origination and underwriting as a primary and detailed illustrative embodiment, the core verification and reconciliation architecture is expressly designed to operate across any domain requiring validated financial data, including but not limited to consumer and commercial lending, insurance underwriting, credit decisioning, account opening, and other applications. References to mortgage-specific workflows, loan products, underwriting systems, and regulatory frameworks throughout this specification are to be understood as non-limiting illustrative examples of the application of the core reconciliation architecture and not as limitations on the scope of the invention.

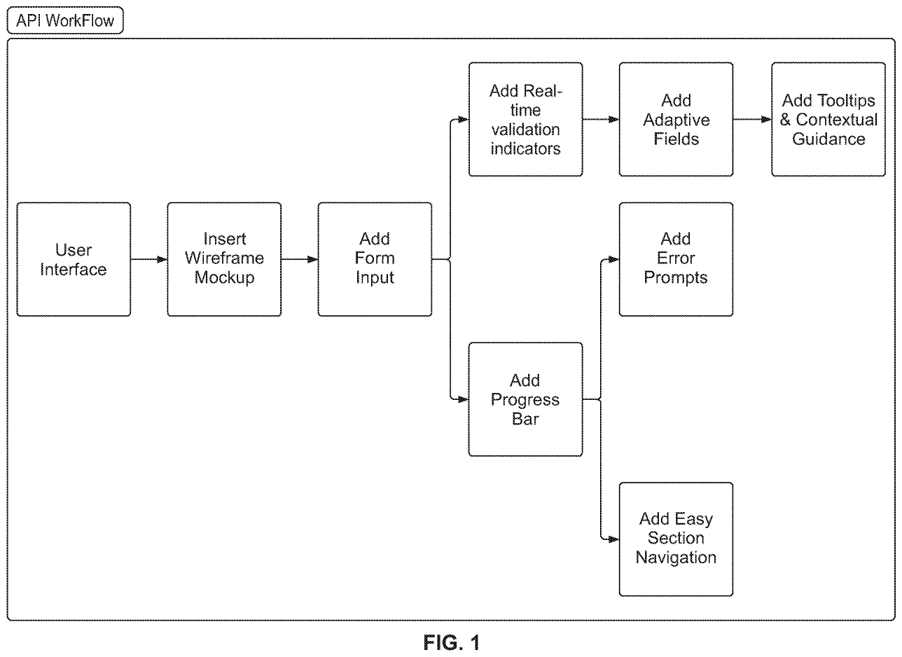

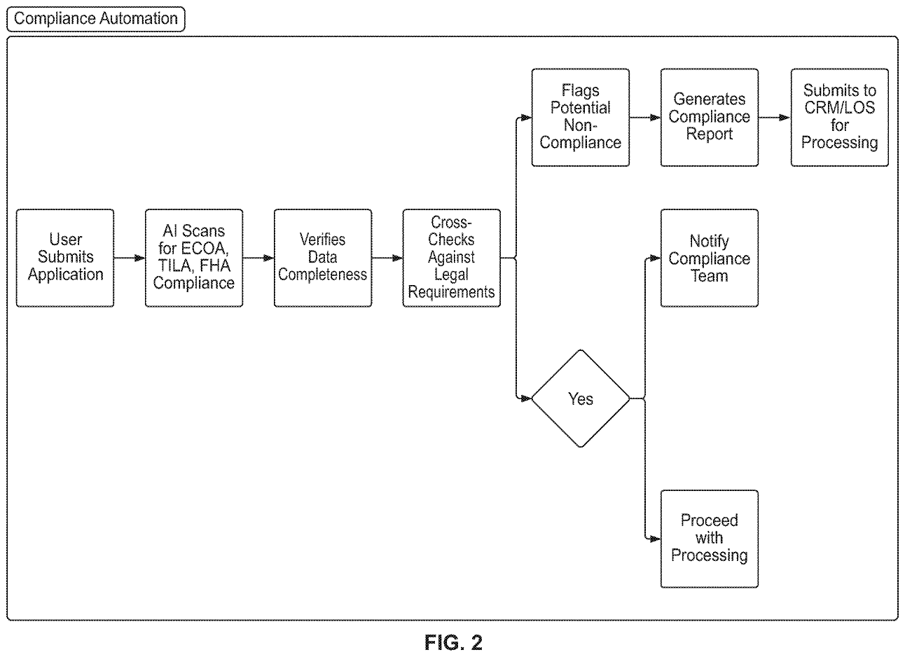

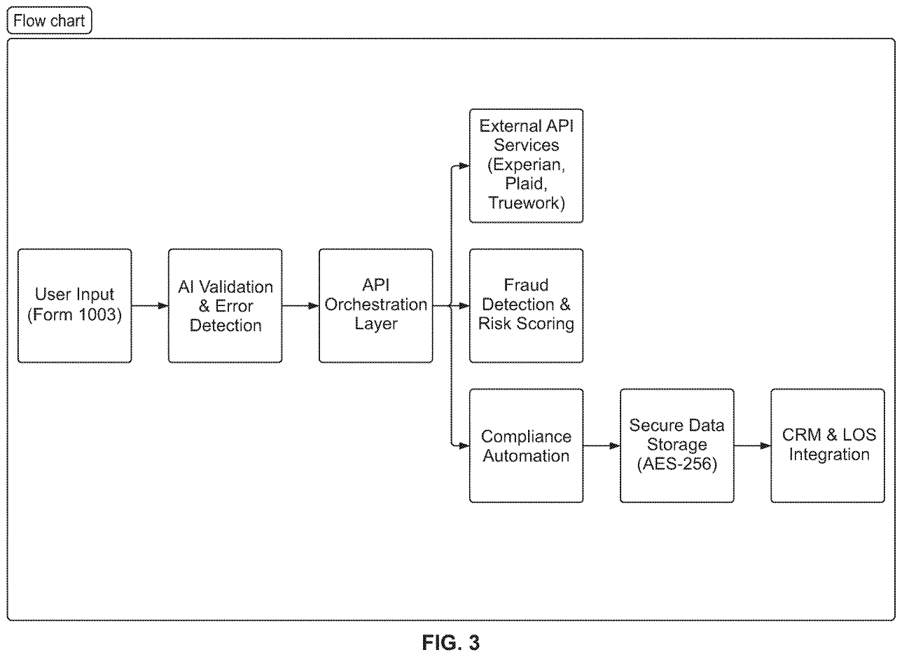

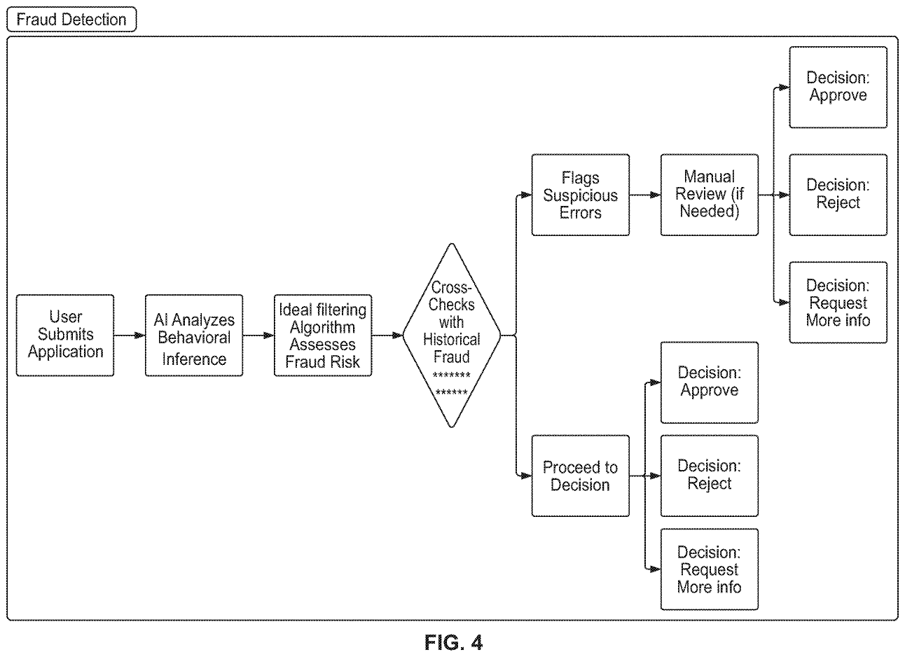

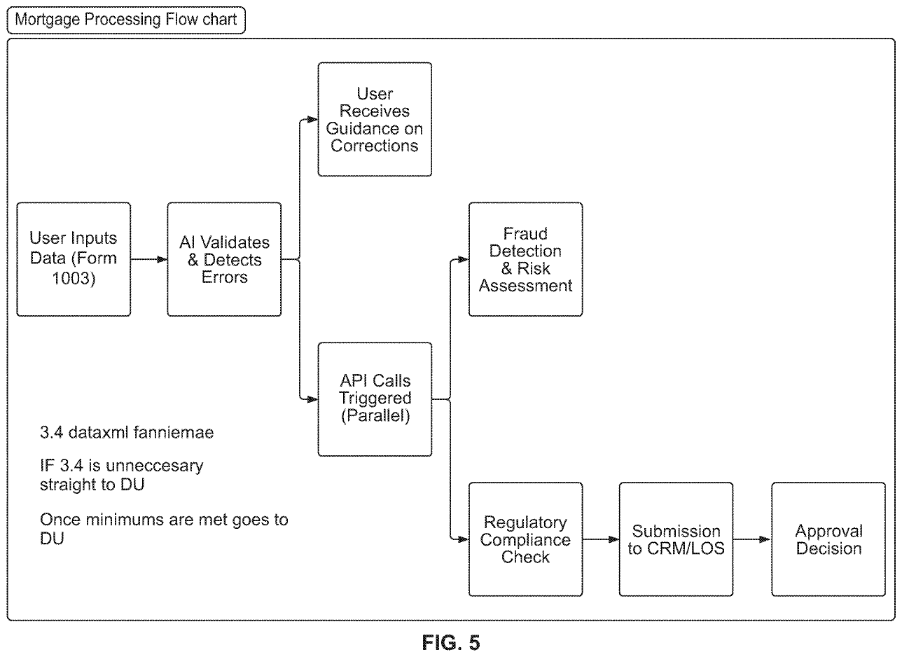

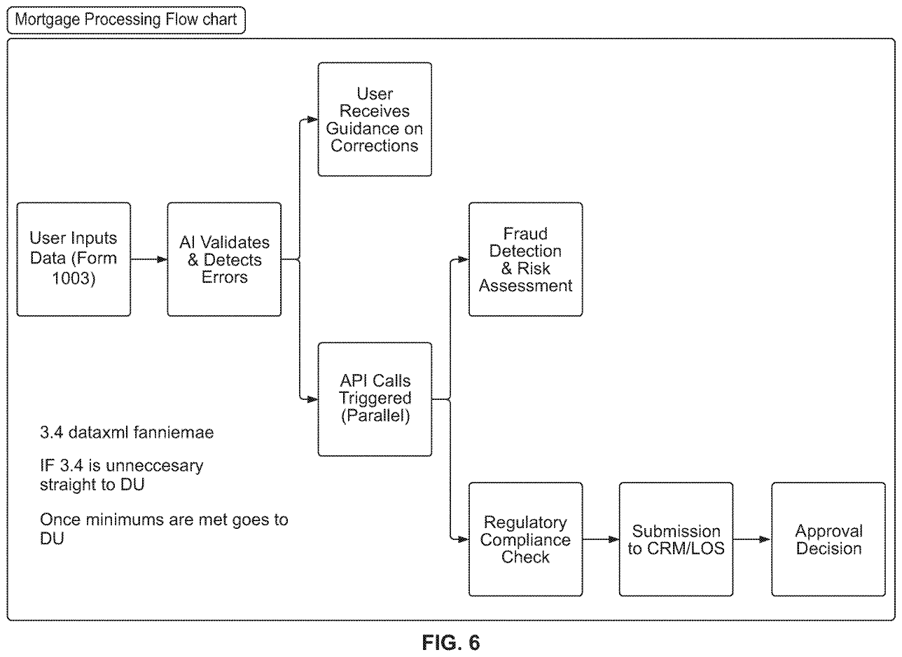

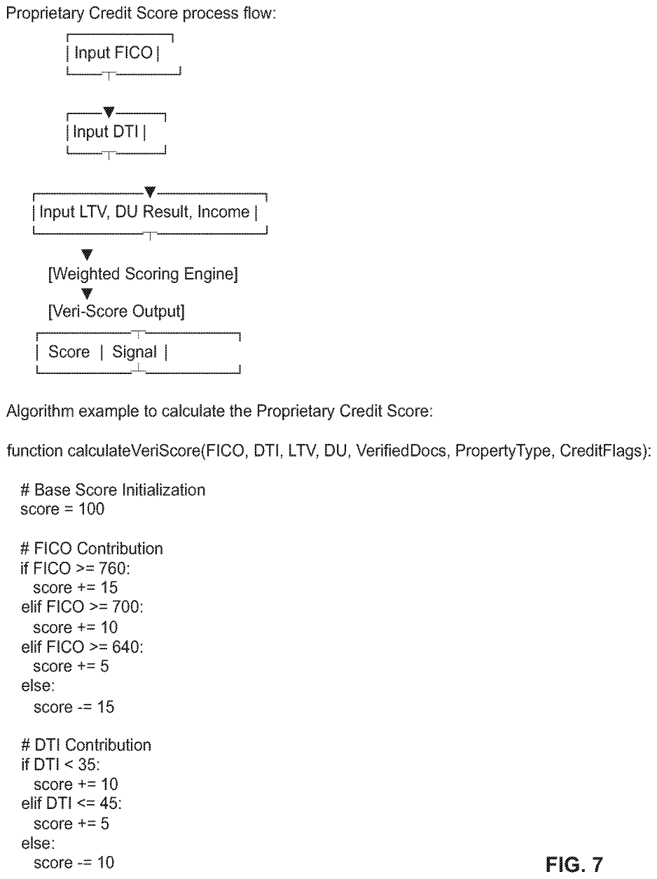

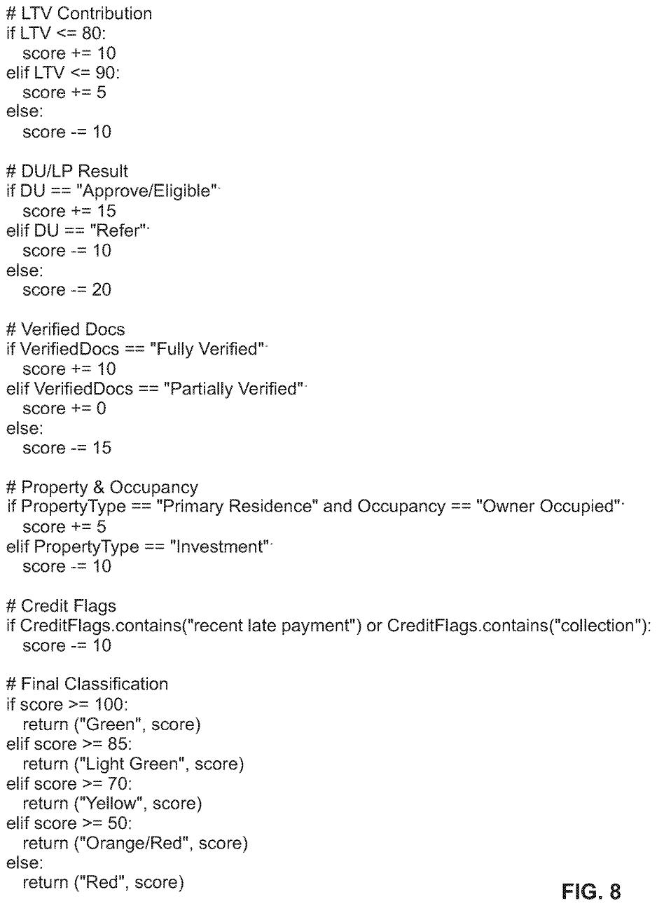

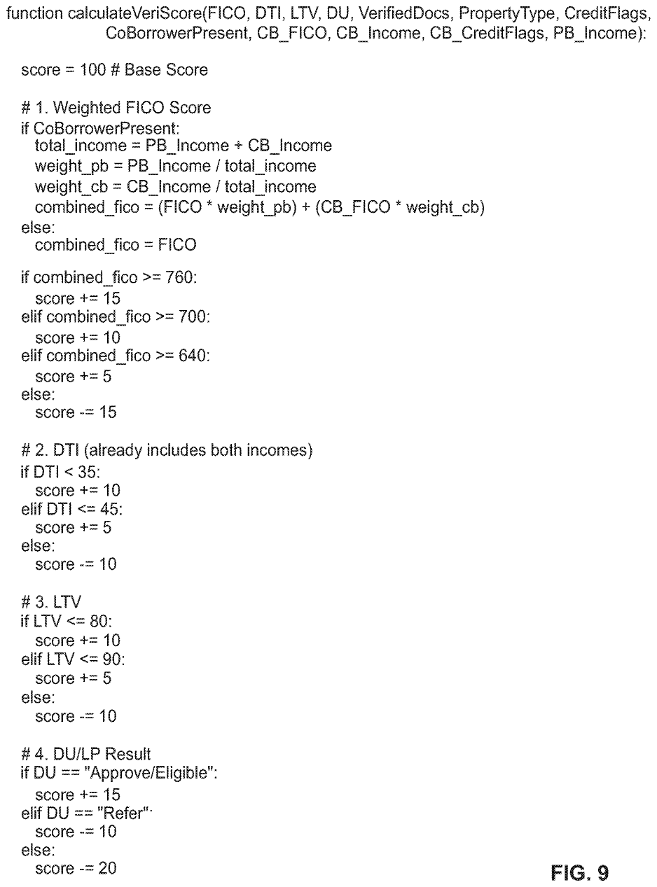

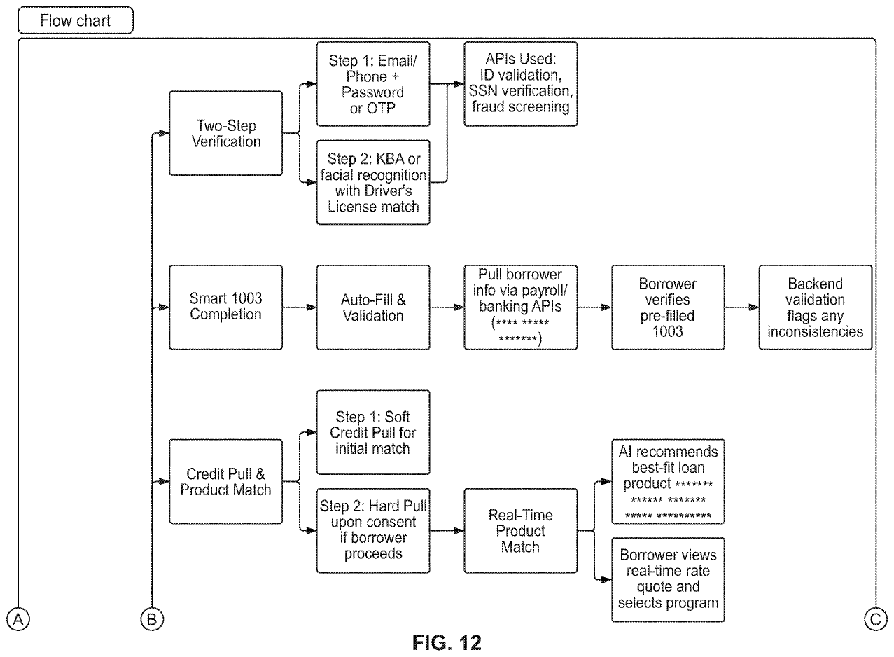

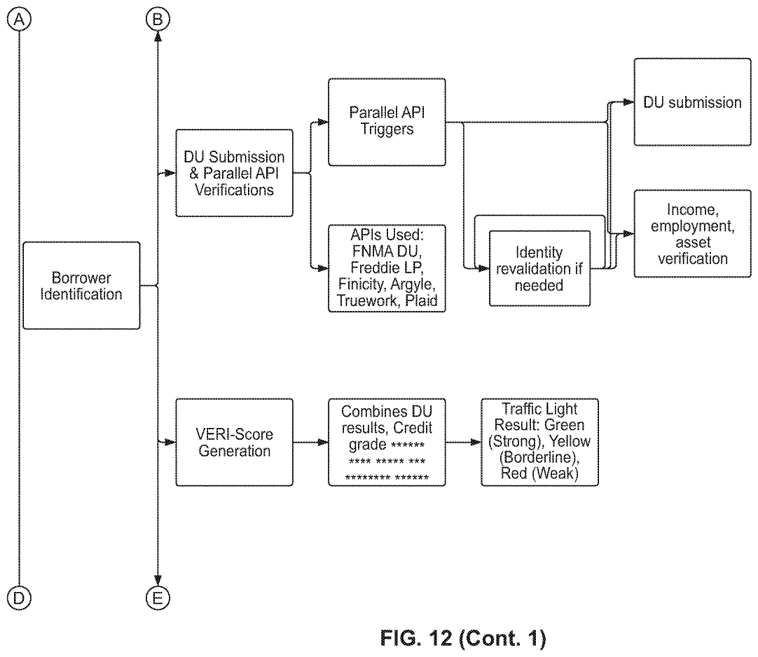

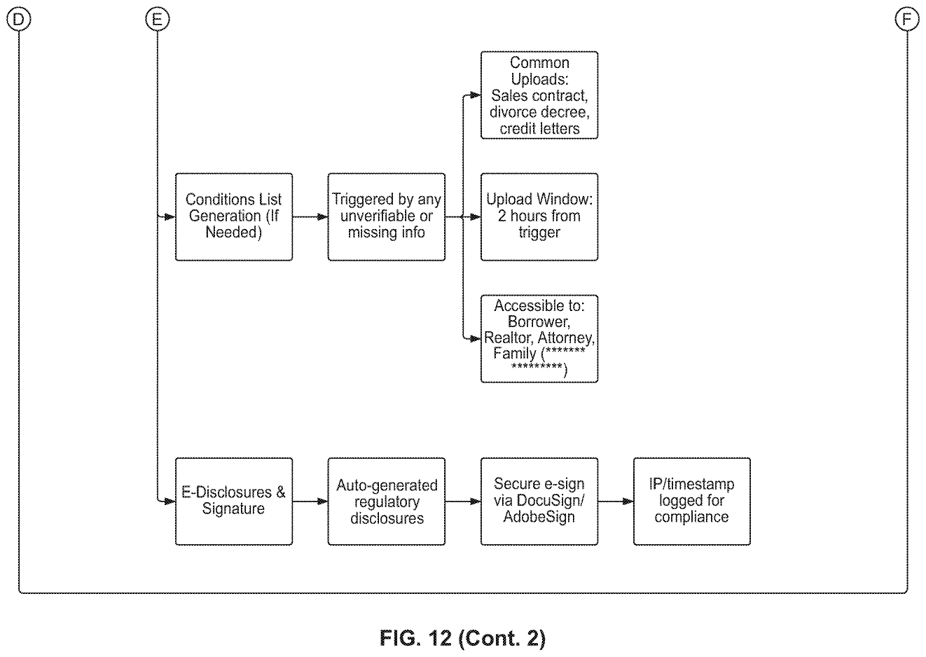

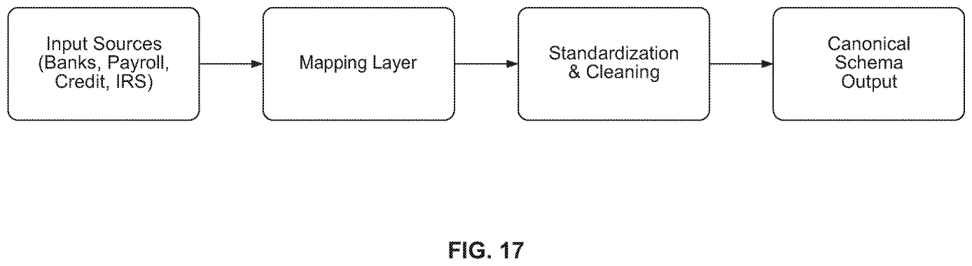

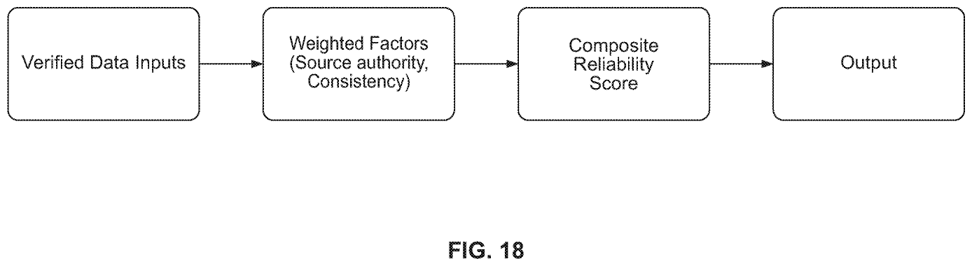

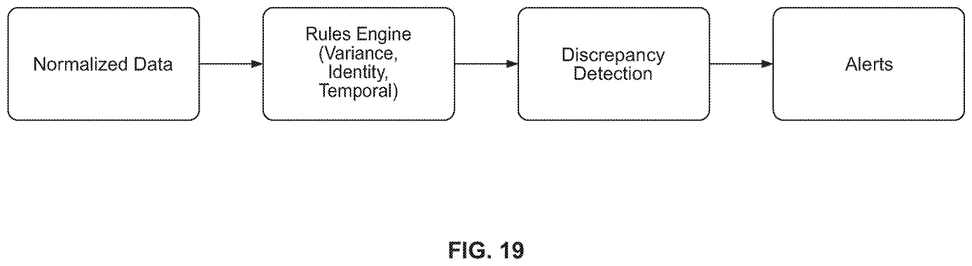

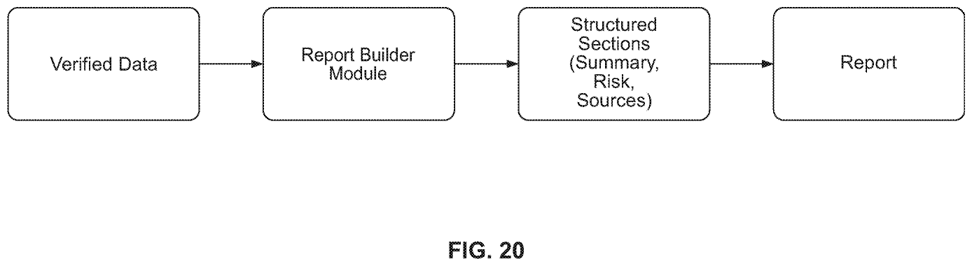

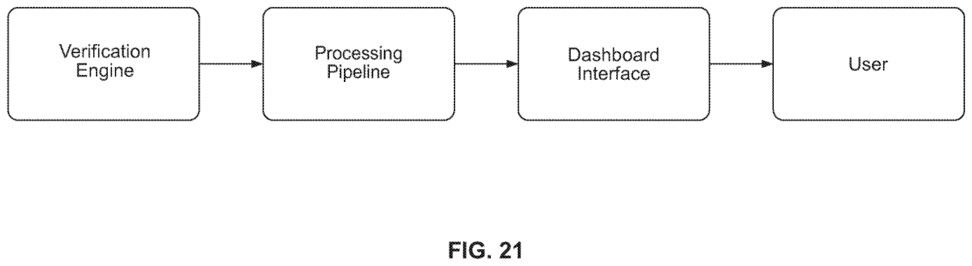

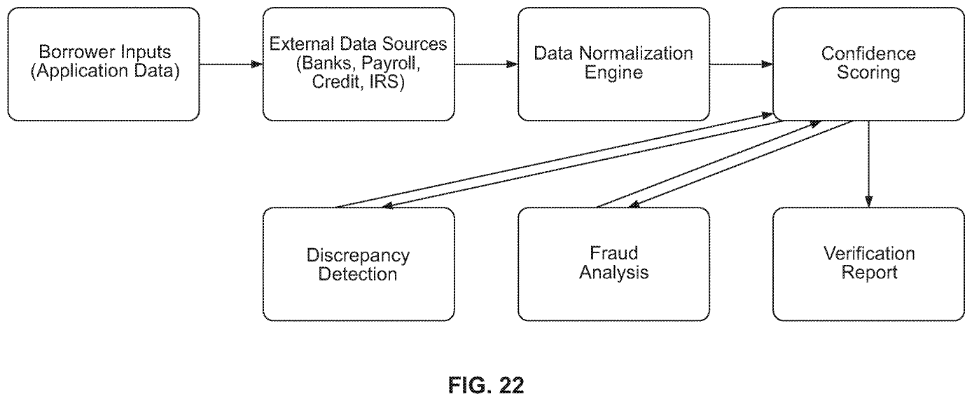

FIGS. 17 through 22 collectively depict the core technical architecture of the evidence reconciliation and verification engine of the present disclosure. FIG. 17 depicts the data normalization engine, FIG. 18 depicts the confidence scoring algorithm, FIG. 19 depicts the discrepancy detector with rules engine, FIG. 20 depicts the structured verification report architecture, FIG. 21 depicts the verification dashboard interface, and FIG. 22 depicts the end-to-end verification and risk assessment system architecture. These figures represent an embodiment of the foundational innovation of the system as disclosed, with FIGS. 1 through 16 depicting illustrative embodiments and application-specific workflows, with more details around a specific implementation primarily in the context of mortgage loan origination, that demonstrate how the core architecture may be applied in practice.

In one embodiment, the system disclosed herein is essentially an evidence reconciliation engine wherein it is architected fundamentally as a financial evidence reconciliation and verification engine rather than a traditional loan origination system (LOS) or workflow automation platform. While the system can integrate with and enhance mortgage lending workflows, its core technical innovation lies in its ability to reconcile conflicting financial data from multiple independent authoritative sources and produce structured verification artifacts with quantifiable confidence measures and full audit trails. This architectural distinction is significant because whereas traditional LOS platforms such as commonly known branded solutions in the marketplace (ICE Mortgage Technology, nCino, Blend, for example) focus primarily on workflow orchestration and loan lifecycle management. In one embodiment, the present system operates as an intermediate trust and adjudication layer that normalizes heterogeneous data, tracks source provenance, detects and resolves discrepancies, scores evidence reliability, and generates verification outputs consumable by downstream decision systems, all without any decisional influence, the decisions coming later in the process.

In one embodiment, the system architecture implements a five-layer processing model: (1) a heterogeneous data ingestion layer that receives borrower data from disparate sources including API responses with varying JSON/XML schemas, CSV files with inconsistent column nomenclatures, OCR-extracted text from PDF documents, and manual user inputs; (2) a canonical normalization layer that maps all ingested data to a unified internal schema, standardizes data types and formats, resolves entity variations (e.g., employer name synonyms), and outputs structured data objects with preserved source metadata; (3) a provenance and lineage tracking layer that maintains for each data element a complete record of its source type, retrieval timestamp, verification method, and authority level; (4) a cross-source reconciliation and confidence scoring layer that compares values for the same logical field across multiple sources, detects discrepancies exceeding predefined thresholds, applies weighting algorithms based on source authority and consistency, and generates field-level and aggregate confidence scores; and (5) a structured verification output layer that produces standardized reports, machine-readable verification objects, and interactive dashboards presenting normalized data, cross-source match matrices, discrepancy indicators, confidence scores, and audit trails. This layered architecture enables the system to function as a reusable, API-accessible verification service that can be integrated into diverse financial applications beyond mortgage lending, including personal loans, commercial credit, insurance underwriting, and financial account opening.

In one embodiment, the system and method of the present disclosure teaches a proprietary, fully integrated, cross platform computer enabled and communicative platform comprising system architecture and workflow with user authentication and security measures, comprising Multi-factor authentication (MFA) using OAuth 2.0 for secure user verification; AES-256 encryption for data storage and TLS 1.3 encryption for secure communications; and role-based access control to protect sensitive information, merging a loan origination system and underwriting with borrower management and post-closing engagement. Security may be further enhanced through implementation of blockchain-based digital signatures guaranteeing the integrity of financial documents, reducing fraud and providing transparency.

In one embodiment, the system and method of the present disclosure teaches credit bureau API integration, comprising, direct API integration with Experian, TransUnion, and Equifax for real-time credit score retrieval; AI-powered aggregation of credit scores, debt obligations, and historical payment behavior; and dynamic credit scoring that adjusts based on historical trends and predictive modeling through AI enabled financial behavior analysis.

In one embodiment, the system and method of the present disclosure implements a proprietary credit score metric that integrates DU findings, real-time verification data, and market conditions and unlike traditional scoring metrics utilized in the mortgage loan processing industry, such as, FICO scores, or any other well-known static credit scoring systems, the proprietary credit score dynamically adjusts based on borrower behavior, alternative lending factors, and real-time lending criteria providing real-time adjustments for the most accurate approval recommendations and implementing an intuitive traffic-light rating system-red-yellow-green, delivering immediate and transparent borrower qualification insights, all according to proprietary weighted individual inputs. The foregoing could be presented in a proprietary report for summarization.

In one embodiment, the system and method of the present disclosure implements a virtual loan officer configured to implement an AI feature, the AILO, that is a proprietary, AI enabled virtual loan officer configured to function as an interactive, real-time decision making assistant that can guide the borrower and adjust loan structuring and lender recommendations dynamically based on changing financial and economic conditions as well as borrower input and a changing proprietary credit score, eliminating traditional bottlenecks. The AILO could have an avatar for more friendly and typical borrower interaction and provide real-time financial insights and rate trend analysis and suggestions.

In one embodiment, the AILO can be customized for any lender to be branded according to their desires, such that it appears to a borrower, the AILO is that lender's real-time assistant, although the AILO would still have all the secure API integrations necessary for direct linking to key verification and underwriting systems allowing for transparent selection of appraisal, title, and insurance providers based on speed, costs and reliability metrics. This component could provide real-time ordering, price comparisons, and include the AILO recommendations.

In one embodiment, the AILO would have continuous borrower engagement, in pre-during- and post-closing of the loan process maintaining borrower retention and providing the borrower with access to a personalized financial assistant throughout all phases of their financial planning process, with full e-signature readiness and compliance at every stage.

In one embodiment, the system and method of the present disclosure utilizes a proprietary rate lock mechanism wherein a rate lock is based upon an analysis of historical market trends, Federal Reserve rate movements, and borrower profiles and input to recommend an optimal rate lock window based on AI-driven forecasts that functions as an intelligent rate lock advisory system feature, providing financial insights, including real-time mortgage loan rate tracking and predictive refinancing alerts. This embodiment would also typically include an economic indicator component tied to rate prediction.

The foregoing embodiments implement specific technical architectures for data verification and risk assessment, as described in detail below.

In one embodiment, the system architecture comprises a series of interconnected processing modules operating on structured data objects. In one embodiment, the processing pipeline comprises, at least, (1) a data ingestion layer that receives borrower data from multiple sources via APIs, file uploads, and manual entry; (2) a data normalization engine that transforms heterogeneous input data into standardized schema-conforming data objects; (3) a confidence scoring algorithm module that calculates weighted reliability scores for each data element and aggregate borrower scores based on proprietary weighting and assigned lender criteria; (4) a discrepancy detector and rules engine that identifies inconsistencies and assigns risk classifications; (5) a fraud detection module that analyzes patterns and generates fraud probability scores; and (6) a report generation engine that produces structured, proprietary verification reports and dashboard displays. Each module operates on defined input data structures and produces defined output data structures, with the output of each module serving as input to subsequent modules in the pipeline. The system maintains a centralized data store containing borrower records, normalized verification data, confidence scores, discrepancy records, and audit logs, with all data encrypted using AES-256 encryption or other more sophisticated techniques as they are developed, and access controlled via role-based access control mechanisms. The system implements a source provenance tracking mechanism wherein each data element in the centralized data store maintains an immutable record of its origin, including source identifier, retrieval method (API, OCR, manual entry), retrieval timestamp, source authority classification, and verification level, thereby enabling full traceability and audit capability for every financial attribute associated with a borrower record. For any given set of inputs, in some embodiments, the system produces a deterministic, reproducible verification output with a traceable, auditable path. It is this reproducibility and tangible output that distinguishes it from probabilistic AI approaches.

In one embodiment, the system and method of the present disclosure utilizes lender matching, a proprietary system approach of continuous refinement of multiple lenders'loan criteria to a borrowers desired goals and approvals, all based in real-time and on continuously updated approvals, borrower qualification shifts, and adaptive risk modeling, and including a feature whereby a borrower may be able to improve their credit score through integrated real-time rescoring options. In this embodiment, there would be an instant, rapid, credit rescoring workflow for a borrower to have near immediate access to the score updates and improved borrowing ability. The AILO would also provide optimized debt strategies to the borrower with suggestions on boosting FICO credit scores.

In one embodiment, the system and method of the present disclosure teaches API-powered risk assessment, comprising, proprietary machine learning models that assess creditworthiness and financial risk; predictive analytics to determine future payment behavior and default likelihood; and adaptive underwriting engine that refines decision-making criteria in real time, all with a comprehensive review of a borrower's overall financial picture to enable refinancing opportunities, credit optimization, and ongoing mortgage loan management.

In one embodiment, the system and method of the present disclosure teaches secure document verification and fraud detection, comprising, AI-driven OCR technology extracts and analyzes critical financial data from documents such as pay stubs, W-2s, tax returns, and bank statements; anomaly detection algorithms flag inconsistencies, document tampering, and synthetic identity fraud; blockchain-based digital signatures ensure document integrity and is expandable to other types of financing, such as auto loans, commercial loans with a holistic financial planning approach. In this embodiment, a fraud risk score is generated based on the perceived accuracy and absence of fraud in the borrower documents and if the risk score meets certain pre-defined thresholds, then an insurer will issue an insurance policy in exchange for a premium and if future fraud is later revealed, the insurance policy will cover the lender losses materially changing the broker-lender dynamics and their contractual relationship of loan buy-back.

In one embodiment, the system implements a proprietary data normalization engine configured to transform heterogeneous borrower data from disparate sources into a standardized, machine-readable verification dataset. The normalization engine receives inputs from multiple sources including, but not limited to, bank transaction CSV exports with varying column nomenclatures, PDF pay stubs processed through OCR extraction, payroll provider API JSON responses, IRS tax transcript data, and manually entered borrower application fields. The engine comprises: (1) a field mapping layer that maps disparate source field names to canonical schema fields using a predefined mapping table; (2) a data type standardization module that converts currency strings, date formats, and categorical values (e.g., pay frequencies) into unified machine-readable formats; (3) an entity resolution component that matches employer names using fuzzy logic algorithms and cross-references against authority databases to resolve naming variations; (4) validation rule processors that flag incomplete or structurally inconsistent data based on predefined data integrity rules; and (5) a schema structuring module that outputs normalized data conforming to a defined internal object model comprising borrower identification, employer information with confidence scores, income data with calculated annualized values, and source metadata including verification levels.

In one embodiment, the standardized output schema generated by the normalization engine comprises structured data objects with defined fields, including but not limited to: a borrower identifier, an employer object containing a normalized employer name and a confidence score representing the degree of match certainty, an income object containing gross year-to-date income, standardized pay frequency codes, and calculated annualized income values, and source metadata identifying the source type and assigned verification level. For example, when the engine receives from a first source a field labeled ‘Gross_Income_YTD’ with pay frequency ‘BW’, from a second source a field labeled ‘YTD Gross’ with frequency ‘Biweekly’, and from OCR extraction the text ‘Gross Earnings Year-to-Date: $82,430.22’, the normalization engine maps all three to a canonical field ‘gross_ytd’ with value 82430.22 and standardized pay frequency code ‘BIWEEKLY’, resolving the semantic and syntactic variations into a uniform data structure. This normalized output serves as the foundational data object for downstream processing modules including the confidence scoring algorithm and discrepancy detector.

In one embodiment, the system implements a multi-factor confidence scoring algorithm that generates quantifiable reliability scores for each verified data element and an aggregate borrower-level trust index. The scoring algorithm applies a proprietary weighted composite scoring model wherein each verified data element receives a score derived from:
(1) a source authority weight assigned based on the verification source type and specific lender criteria, with direct API connections to authoritative sources receiving higher weights than borrower-uploaded documents; (2) a data consistency match score calculated as the percentage degree of matching across multiple independent sources for the same data element; (3) a historical stability indicator reflecting consistency of the data element over time; (4) a field-level validation integrity score based on structural and logical validation checks; and (5) fraud pattern indicators derived from anomaly detection algorithms. In one exemplary weighting model, the source authority weight is assigned 35% of the total score, cross-source match degree is assigned 30%, consistency over time is assigned 15%, structural validation is assigned 10%, and fraud pattern screening is assigned 10%, though the specific weightings may be configured based on lender requirements and risk tolerance.

In one embodiment, the confidence scoring algorithm generates both field-level scores and an aggregate borrower reliability index. For example, the system may generate an income confidence score of 87/100, an employer match score of 92/100, and an identity match score of 95/100, which are then combined using weighted averaging to produce an aggregate borrower reliability index of 89/100. The system further implements a color-coded risk mapping framework that categorizes scores into defined risk bands wherein, for example, a green classification for scores of 85-100 indicating high reliability, a yellow classification for scores of 70-84 indicating moderate review recommended, and a red classification for scores below 70 indicating manual review required. The scoring output comprises both the numeric scores and categorical risk classifications, enabling both automated decision-making based on threshold rules and human reviewer assessment via intuitive visual indicators. The confidence scores and risk classifications are stored in association with the borrower record and are incorporated into the structured verification reports generated by the system.

In one embodiment, the system implements a discrepancy detector and rules engine configured to identify material inconsistencies across data sources and assign structured risk ratings. The discrepancy detector employs multiple detection methodologies including, for example, (1) field-level variance threshold rules that flag discrepancies exceeding predefined percentage thresholds, such as income variances greater than 5%; (2) logical inconsistency checks that identify incompatible data combinations, such as pay frequency values that are mathematically inconsistent with reported annual income; (3) temporal pattern detection algorithms that identify anomalous changes such as sudden income spikes or employment changes occurring immediately prior to loan application; (4) employer database cross-verification that validates employer information against authoritative business registries; and (5) identity mismatch detection that identifies inconsistencies across social security numbers, addresses, and name variations. Each detection rule is assigned a severity classification and generates structured discrepancy records when triggered.

In one embodiment, when the discrepancy detector identifies a material inconsistency, the system executes a defined sequence of actions comprising, at least, (1) assigning a structured discrepancy classification identifying the discrepancy type and severity level, such as ‘Income Variance-Moderate’; (2) adjusting the affected confidence scores and aggregate borrower reliability index downward based on predefined adjustment factors; (3) generating a timestamped audit log entry recording the discrepancy details, affected data fields, and system response; and (4) producing a structured risk explanation that is incorporated into the verification report output. For example, when the system detects that a borrower-reported year-to-date income of $82,430 differs from a payroll API-verified year-to-date income of $ 75,910 by 8.5%, exceeding the 5% tolerance threshold, the system assigns a yellow risk flag, reduces the income confidence score, logs the variance with supporting data from both sources, and generates an explanation indicating ‘Income discrepancy detected: Application-reported income exceeds verified payroll data by 8.5%’ for inclusion in the verification report.

In one embodiment, the system generates structured proprietary verification output reports, essentially a report on the outcome of verification, comprising a standardized architecture with defined sections and data presentation formats. In one embodiment, this report comprises: (1) a borrower identification summary section containing verified identity information; (2) a normalized data table presenting verified data elements in the canonical schema format; (3) a cross-source match matrix displaying the degree of agreement across multiple verification sources for each data element; (4) a risk indicator panel presenting the color-coded risk classifications (green/yellow/red) for each scored element and the aggregate borrower level; (5) a fraud probability score presented as a decimal value indicating estimated fraud risk; (6) an underwriter recommendation layer providing automated guidance based on the aggregate risk assessment; and (7) timestamped verification metadata documenting when each verification was performed and which sources were consulted. The structured report format enables both automated consumption by downstream underwriting systems via API and human review via a graphical user interface (GUI).

In one embodiment, the system further generates a borrower verification dashboard interface, essentially a proprietary dashboard display, that presents verification results in a visual format comprising, at least, (1) a field-level discrepancy table identifying each detected discrepancy with supporting data from conflicting sources; (2) a fraud probability score display presenting the calculated fraud risk score with visual indicators; (3) a source authority summary showing which authoritative sources were successfully queried and their respective verification levels; (4) an audit trail metadata panel providing a chronological record of verification activities; and (5) a summary verification status indicator providing at-a-glance assessment of borrower verification completeness and reliability. The dashboard interface is dynamically generated based on the verification data and confidence scores generated by the system, providing real-time visibility into verification status as data is collected and processed. In one embodiment, the dashboard display implements a hierarchical information architecture wherein summary indicators are presented prominently with drill-down capabilities to access detailed field-level verification data and source documentation.

While specific weighting factors and threshold values have been disclosed above (e.g., 35% source authority weight, 5% variance threshold), it will be understood that these values may be adjusted based on lender requirements, regulatory changes, or machine learning optimization without departing from the inventive principles of the multi-factor confidence scoring and threshold-based discrepancy detection framework.

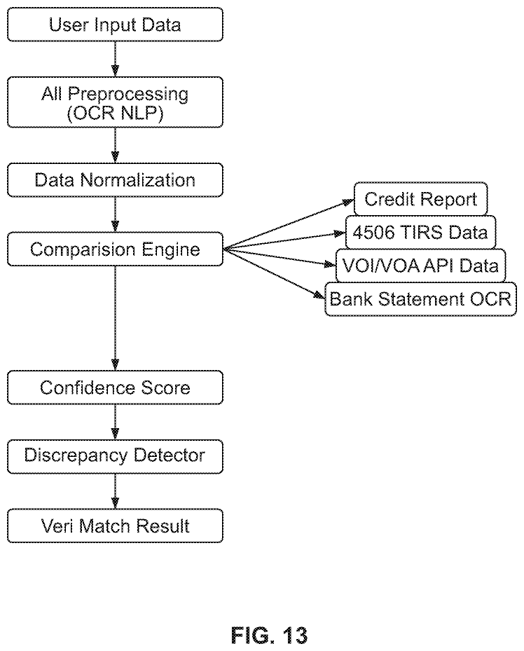

Referring to FIG. 13, in one embodiment, there would be an intelligent data reconciliation and risk detection engine component wherein, a borrower, upon uploading or inputting data through a standard 1003 mortgage application form or otherwise inputting via a web or mobile interface, which data would typically include personal identifying information, employment and income details, asset and liability disclosures, and uploaded documents containing such information, the engine then employs an AI processing layer comprising an optical character recognition capability, and natural language processing component to normalize and extract data, and associate recognized entities with known databases. Then, the engine would standardize the extracted data and begin a comparison among various databases and generate a score based on a scoring algorithm that assigns various weights based on the level of verification, source authority, degree of match/mismatch, document metadata, and the like to generate an overall match score, triggering a risk rating and risk analysis to identify and point out discrepancies. Final output would be based on such scores and assessments with an audit trail and suggested next steps.

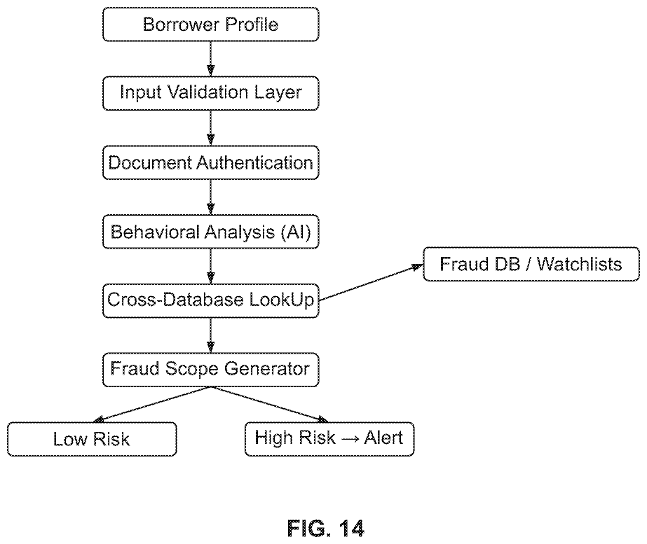

Referring to FIG. 14, in one embodiment, there would be an AI driven fraud detection and metric based risk scoring component wherein, based on borrower inputs and submitted documents, APIs are utilized to pull and refresh third-party data in real time and as just discussed, extract, normalize, and compare data to evaluate patterns and based on similar assigned authority metrics assign a risk score and cross reference results against various known identity and property databases comprising OFAC watchlists, FINCEN, and internal lender blacklists to modify such risk score.

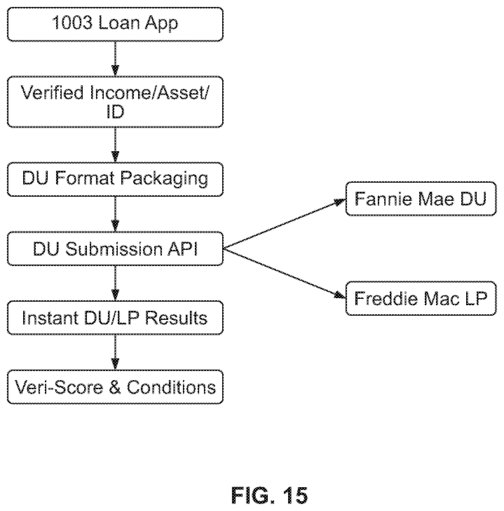

Referring to FIG. 15, in one embodiment, a workflow could consist of a borrower submitting their loan application information, through a standard 1003 mortgage application or otherwise via the system interface and uploading all needed and requested documentation, automated ordering of required verifications including an IRS 4506-C transcript, credit pulls, income and asset validations, employment validation, and identity and fraud checks as just described. There would be an underwriting submission engine with DU Casefile ID generation, reissuance of credit report token, and data mapping for accuracy. Based on key ratios such as DTI, LTV, and credit risk scoring, and fraud risk scoring, the system would generate a conditions clearing report for outstanding items for borrower and lender leading to a approval score for movement to processing, closer review or all stop, ineligible. Once fully cleared, if applicable, a closing package is generated for closing, with required elements, and optional elements.

In one embodiment, the system and method of the present disclosure teaches AI-enabled data verification of all borrower criteria needed for borrower life insurance during the loan origination process. This would include age, credit score, general known health parameters and all criteria as typically required by participating life insuring companies. The system would also be tied into the participating life insuring companies for rates and underwriting such that if a borrower were desiring life insurance to cover the mortgage loan principal balance to protect their family from unforeseen tragedy, the system would match such borrowers and life insuring companies by leveraging APIs and predictive modeling to match borrowers with optimal insurance products. Such a transaction could be part of the overall mortgage loan closing (with preferred mortgage loan rates for borrowers choosing to have such insurance built into their monthly mortgage loan payments as the lender would be more secure), or could also be a separate transaction, just facilitated by the system.

In one embodiment, the system and method of the present disclosure teaches real-time banking transaction analysis, comprising, integration with Plaid (or other income verification platform) API enables automated and secure income verification; AI models analyze spending behavior, cash flow trends, and financial stability indicators; and behavioral scoring identifies discrepancies between reported and actual financial activity.

In one embodiment, the system and method of the present disclosure teaches automated loan prequalification and decisioning, comprising, AI-powered underwriting models automate prequalification based on lender-defined parameters; rule-based decision engines enable real-time application approval and risk mitigation; and API-enabled document submission and tracking to streamline lender communications.

In one embodiment, the system and method of the present disclosure teaches compliance and audit logging, comprising, built-in compliance mechanisms for GDPR, CCPA, SOC2, and relevant mortgage industry regulations; encrypted, tamper-proof audit logs for real-time tracking and regulatory oversight; and AI-powered compliance monitoring to detect potential violations.

In one embodiment, there would be a unified login and verification procedure across all services and components that ties one borrower to all components and services simplifying the ability of the borrower to access everything through one unified platform. Included in this could be a buyer-seller platform with or without realtors to have a more robust property marketplace.

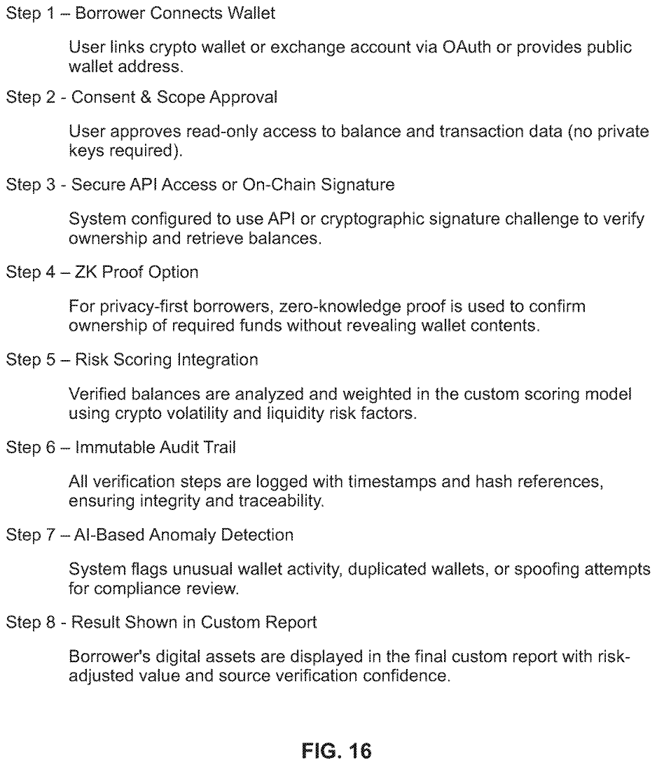

Given the landscape of the current accumulation of wealth and assets of varying types, including but not limited to digital assets such as cryptocurrency, NFTs, and the like, in one embodiment, it is desirable to have a method and process for verifying the value and ownership of such asset categories. Referring to FIG. 16, it is envisioned that such a process could be implemented to allow an unbiased asset verification service access to a cryptocurrency or asset exchange account with read-only access for security reasons to value and verify ownership of such assets according to the process flow shown. In this embodiment, it is not necessary for any private keys to ever be collected and access is limited to balance and transaction history, but implementing certain owner verification steps, such as a signature challenge requiring the owner to sign a message with their private key to verify ownership.

Referring to FIGS. 1 through 6, disclosed are multiple embodiments of the system and architecture flow, showcasing API integrations, AI-powered workflows, and automation components. In one embodiment, disclosed is a data flow diagram comprising mapping credit retrieval, document verification, fraud detection, and underwriting processes. In an alternate embodiment, an AI risk assessment model flowchart is described depicting AI decision logic for borrower risk evaluation.

FIGS. 7 through 10 disclose one embodiment and one example of the calculation of the proprietary credit score disclosing the metrics and the weighting of the contemplated various individual inputs described leading to a color end result recommendation.

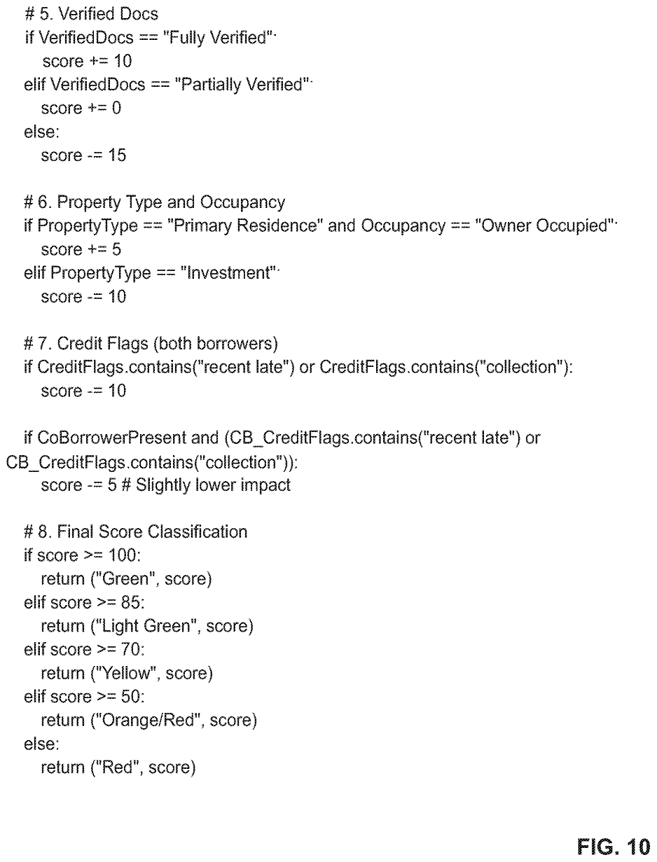

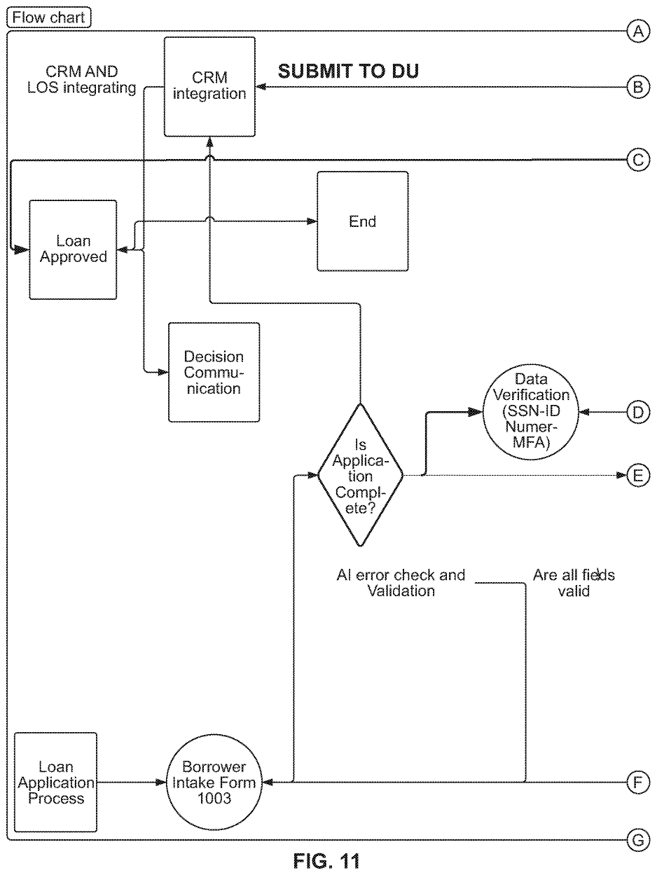

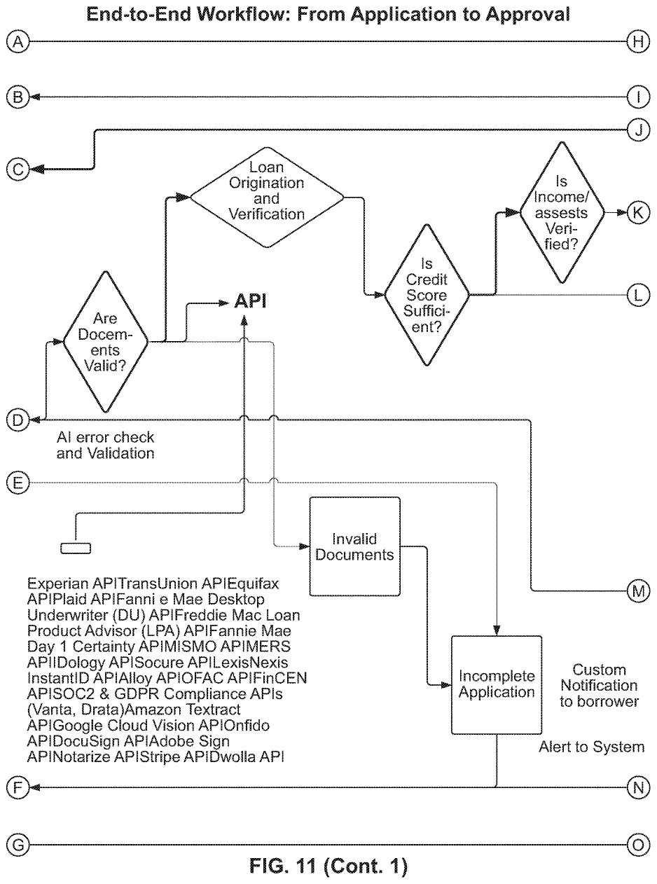

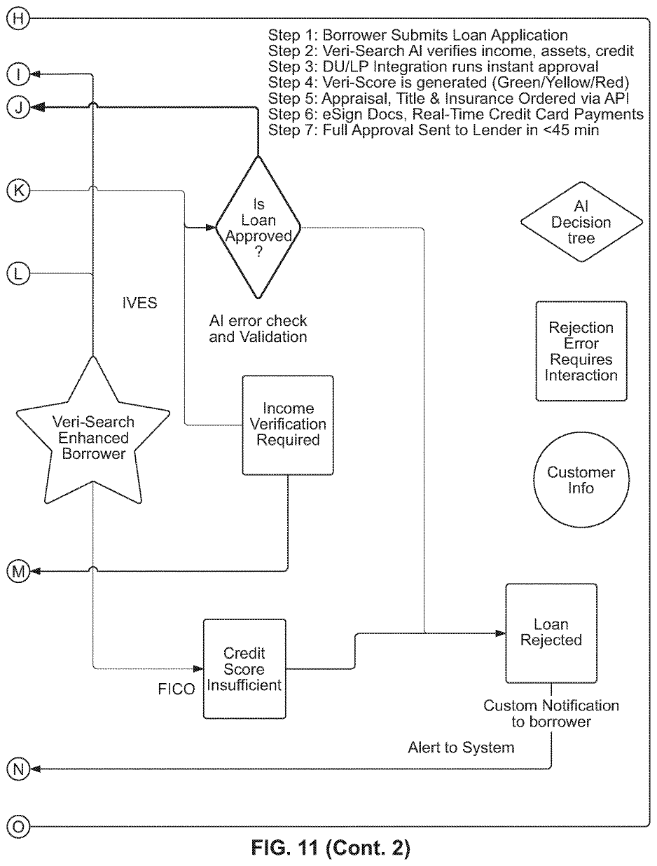

FIG. 11 discloses one embodiment of a full flow diagram of a platform disclosed herein evidencing: Step 1—borrower submits an application; Step 2—AILO receives the application and undertakes to verify income, assets, credit and other tasks of borrower interaction; Step 3 the AILO assists with underwriting and runs all approval checks; Step 4—proprietary credit score metric is generated and returns a color scale approval recommendation; Step 5—assuming a lender approval of the returned recommendation, the AILO assists with coordination of appraisal, title and insurance via integrated APIs; Step 6—document preparation, esignatures, payment coordination and full closing package preparation; Step 7—full approval sent to lender for funding; and Step 8—post-closing borrower management. In this embodiment, there is also potential for loan document re-submission and instant real-time reverification of the proprietary credit score depending on initial findings, with true end-to-end automation.

In one embodiment, the system and method of the present disclosure redesigns the mortgage loan lending process by combining real-time loan origination with instant verification and automated underwriting, to not only compete, but to enhance approval efficiency and reduce or eliminate borrower default to serve as an all-in-one Loan Origination System (LOS) with a fully integrated AILO. Unlike traditional platforms that rely on manual processes and prolonged approval times, the system and method disclosed herein enables borrowers to complete an application, receive real-time DU findings, undergo necessary verifications, and select from qualified mortgage options all within minutes and with Predictive Rate Lock Optimization to ensure the borrower is making the best decision possible and reduce any likelihood of default because the proprietary credit score and AILO combination provides a much more robust predictor of creditworthiness in real-time than could any traditional method of approval. Moreover, the AILO would be able to provide personalized tutorials and learning paths customized for each borrower in real time and as the borrower learns, the tutorials and learning paths updated for more sophisticated and advanced learning.

In one embodiment, once the loan is closed for a borrower, the system and method of the present disclosure is not finished, but instead can transition to a marketing campaign tool and borrower advocate aimed at maintaining retention, offering refinance options as conditions warrant, providing the borrower with mortgage updates, financial insights, credit card monitoring, loan consolidation options and a host of other continuing interactions with the borrower.

In one embodiment, the system and method of the present disclosure is not limited to just mortgage loan approvals, but can be implemented in any credit approval and loan closure situation for a borrower, such as, but not limited to, auto loans, boat loans, credit card approvals, commercial lending, personal loans, and a wide range of funding applications, and with respect to any one borrowers, or combination of borrowers, integrates all such financial transactions such that each approval is guided by the entire picture and not limited to a single set of disclosures, including all historical aspects for any one or set of borrowers.

### EXAMPLES

The present invention is further illustrated, but not limited by, the following examples.

In one embodiment, the platform enables a borrower to forego a traditional loan officer application process and complete a Form 1003 (the current mortgage loan application form) with an AI-driven real-time validation and receive underwriting decisions and finalize a loan application without traditional loan officer intervention.

In this embodiment, the borrower would be prompted with dynamic form guidance which would adjust fields based on user responses in real-time. In this embodiment, there would be back-end API orchestration providing automated API calls to multiple credit bureaus (as a non-limiting example, Experian), repositories of banking data (as a non-limiting example, Plaid), and employment verification services (as a non-limiting example, Truework).

In this embodiment, there would be a fraud detection module comprising behavioral biometrics configured to analyze typing speed, mouse movement and other input characteristics to detect anomalies and flag suspicious activity for further analysis and verification. In another embodiment, fraud detection could be extended to wire transfers such that at the time of any wire transfer in connection with any transaction contemplated within the system of the present disclosure, alerts, risk scores, or other means of informing the parties involved in the wire transaction of such risk and require express approval based on that risk to complete the transaction.

In this embodiment, the system as described would further comprise a compliance automation tool for real-time checks of all information and process conforming to applicable regulations, including but not limited to, ECOA, TILA, and FHA regulations, as they are updated in real-time and in compliance with GDPR and CCPA guidance and SOC-2 security, with integrated, encrypted audit trails.

In this embodiment, the system would comprise secure data storage according to industry standards including at least, AES-256 encryption, and Role Based Access Controls.

In this embodiment, the system, through the implementation of AI enabled processes, data would be validated for automatic transmission and the overall process will be enhanced for more efficient and accurate underwriting decision making through risk scoring models.

In one embodiment, the system implements AI-driven underwriting decisions, combining risk assessment, predictive modeling, and anomaly detection to provide the most precise, real-time credit approvals available.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

Each and every feature described herein, and each and every combination of two or more of such features, is included within the scope of the present invention provided that the features included in such a combination are not mutually exclusive.

What is claimed is:

1. A computer-implemented financial data verification and risk assessment system comprising:
a processor;
a memory storing executable instructions; and
a data normalization engine executed by the processor and configured to:
receive applicant data from a plurality of heterogeneous data sources, wherein the heterogeneous data sources comprise at least two of: bank transaction data files with varying column nomenclatures, optically character recognized text from scanned financial documents, payroll provider API responses, tax transcript data, and manually entered application data;
apply a field mapping layer that maps disparate field names from the plurality of heterogeneous data sources to canonical schema field names according to a predefined mapping table;
apply a data type standardization module that converts values from the plurality of heterogeneous data sources into unified data formats, wherein the data type standardization module converts at least currency strings and pay frequency categorical values into pre-defined standardized formats;
apply an entity resolution component that matches employer name variations from different data sources using fuzzy logic matching and cross-references matched employer names against an authority database to generate employer name confidence scores;
generate a normalized data object conforming to a predefined canonical schema, wherein the normalized data object comprises: an applicant identifier, an employer data structure containing a normalized employer name and an associated confidence score, an income data structure containing a gross year-to-date income value and a standardized pay frequency code, and source metadata identifying a source type and verification level for each data element;
a confidence scoring engine configured to calculate, for each data element in the normalized data object, a weighted composite confidence score by assigning pre-defined source authority weights based on a source type of the data element, wherein direct API connections to authoritative sources receive higher source authority weights than applicant-uploaded documents;
calculating a cross-source consistency score representing a degree of matching for the data element across multiple independent data sources;
calculating a field-level validation integrity score based on structural and logical validation checks applied to the data element; and
combining the source authority weight, cross-source consistency score, and field-level validation integrity score according to predefined weighting factors to generate the weighted composite confidence score;
calculate an aggregate applicant reliability index by combining weighted composite confidence scores for a plurality of data elements associated with an applicant; and
assign a categorical risk classification to the aggregate applicant reliability index based on predefined threshold ranges, wherein the categorical risk classification comprises at least a high reliability classification for scores within a first range, a moderate review classification for scores within a second range lower than the first range, and a manual review required classification for scores below the second range.

2. The system of claim 1, further comprising a discrepancy detector and rules engine configured to:
apply a plurality of discrepancy detection rules to the normalized data object, wherein the plurality of discrepancy detection rules comprise:
a field-level variance threshold rule that flags a discrepancy when a percentage difference between values of a same data field from different sources exceeds a predefined threshold percentage;
a logical inconsistency rule that identifies incompatible combinations of data values; and
a temporal pattern detection rule that identifies anomalous changes in applicant data occurring within a predefined time period; and
when a discrepancy detection rule is triggered:
generate a structured discrepancy record identifying a discrepancy type and a severity classification;
adjust at least one weighted composite confidence score associated with data elements affected by the triggered discrepancy detection rule;
recalculate the aggregate applicant reliability index based on the adjusted weighted composite confidence score; and
generate a timestamped audit log entry recording discrepancy details and system response; and
output the structured discrepancy record for inclusion in a verification report.

3. The system of claim 2, further comprising a report generation engine configured to:
generate a structured verification report comprising:
a normalized data table presenting verified data elements in the predefined canonical schema format;
a cross-source match matrix displaying, for each of a plurality of data elements, a degree of agreement across multiple verification sources;
a risk indicator panel presenting the categorical risk classifications for scored data elements and the aggregate applicant reliability index, wherein the risk indicator panel implements a color-coded visual classification system;
a field-level discrepancy table identifying each detected discrepancy with supporting data from conflicting sources; and
timestamped verification metadata documenting when each verification was performed and which sources were consulted; and
wherein the structured verification report is formatted for both automated consumption by downstream underwriting systems via an application programming interface and human review via a graphical user interface.

4. The system of claim 2 further comprising a fraud detection module configured to analyze the normalized data objects, confidence scores, and structured discrepancy records to generate a fraud probability score wherein the fraud detection module implements anomaly detection algorithms comprising at least one of: sudden income spike detection, employment change timing analysis, exceeding predefined expectation of consistency that comprises identifying all available sources that provided a value for the data element, comparing values from the available sources, and calculating said predefined expectation of consistency value, and synthetic identity pattern recognition.

5. The system of claim 4 wherein an applicant is a borrower applying for a loan.

6. The system of claim 4 further comprising a blockchain-integrated document verification system ensuring authenticity and preventing document forgery.

7. The system of claim 1, wherein the fuzzy logic matching comprises calculating a minimum number of changes needed to be made between disparate employer name strings and determining a match when said number of changes is below a predefined threshold.

8. The system of claim 1, wherein the predefined weighting factors comprise:
35% weight for source authority, 30% weight for cross-source consistency score, 15% weight for historical stability, 10% weight for structural validation, and 10% weight for fraud pattern indicators.

9. The system of claim 3, wherein the color-coded visual classification system comprises: green color coding for high reliability classifications corresponding to scores of 85-100, yellow color coding for moderate review classifications corresponding to scores of 70-84, and red color coding for manual review required classifications corresponding to scores below 70.

10. The system of claim 4, further comprising an insurance underwriting module configured to: receive the fraud probability score from the fraud detection module; compare the fraud probability score to predefined insurance eligibility thresholds; and
when the fraud probability score is below a threshold value, generate an insurance offer with a premium calculated based on the fraud probability score.

11. A computer-implemented method for financial data verification and risk assessment comprising:
receiving, via a processor, applicant application data through a user interface, wherein the applicant application data comprises at least applicant identification information, employment data, income data, and asset data;
automatically initiating, by the processor, data collection from a plurality of verification sources based on the received applicant application data, wherein the plurality of verification sources comprise at least two of: credit bureau APIs, payroll provider APIs, bank transaction data sources, and tax authority data sources;
executing, by a data normalization engine, a normalization process on collected data from the plurality of verification sources by:
mapping disparate field names from the plurality of verification sources to canonical schema field names according to a predefined mapping table;
converting values from the plurality of verification sources into unified data formats; and
generating a normalized data object conforming to a predefined canonical schema;
calculating, by a confidence scoring engine, weighted composite confidence scores for data elements in the normalized data object by combining source authority weights, cross-source consistency scores, and validation integrity scores according to predefined weighting factors;
calculating, by the confidence scoring engine, an aggregate applicant reliability index based on the weighted composite confidence scores;
applying, by a discrepancy detector, threshold-based discrepancy detection rules to the normalized data object to identify material inconsistencies across the plurality of verification sources;
when a material inconsistency is detected, adjusting the aggregate applicant reliability index downward based on a severity classification assigned to the material inconsistency;
assigning, by the processor, a categorical risk classification to an applicant based on comparing the aggregate applicant reliability index to predefined threshold ranges; generating, by the processor, an approval recommendation based on the categorical risk classification; and
when the approval recommendation indicates approval eligibility, automatically generating, by a document generation module, a structured output package comprising documentation populated with verified data elements from the normalized data object.

12. The method of claim 11 wherein the applicant is a borrower applying for a mortgage loan, and wherein the structured output package comprises a closing package including loan documentation conforming to applicable mortgage loan regulatory requirements, populated with verified data elements from the normalized data object.

13. A computer-implemented financial data reconciliation and verification system operable as an independent trust layer for downstream financial decision-making systems, the system comprising:
a processor;
a memory storing executable instructions; and
a data ingestion layer configured to receive applicant data from a plurality of heterogeneous authoritative sources, wherein each source has an independently assigned authority level, and wherein the plurality of heterogeneous authoritative sources comprise a plurality of components from the set comprising: API-connected data sources, optically character recognized text from scanned financial documents, structured file uploads with varying field nomenclatures, and manually entered application data;
a canonical normalization engine configured to transform ingested applicant data from the plurality of heterogeneous authoritative sources into a standardized, schema-conforming normalized data object, wherein the canonical normalization engine preserves, for each data element in the normalized data object, source provenance metadata comprising at least a source identifier, a retrieval method, a retrieval timestamp, and an assigned authority level;
a cross-source reconciliation engine configured to compare values for each logical data field across data elements from multiple sources in the normalized data object, detect discrepancies exceeding predefined threshold levels, and generate structured discrepancy records identifying discrepancy type, severity classification, and affected data elements;
a multi-factor confidence scoring engine configured to assign a weighted composite confidence score to each data element in the normalized data object based at least on source authority weight, cross-source consistency score, and field-level validation integrity score, and to calculate an aggregate applicant reliability index from the weighted composite confidence scores; and
a structured verification output engine configured to generate a machine-readable verification artifact comprising the normalized data object, the aggregate applicant reliability index, the structured discrepancy records, and source provenance metadata, wherein the machine-readable verification artifact, executed upstream of and is then consumable by downstream financial decision systems via an application programming interface without requiring human review prior to consumption.

14. The system of claim 13, wherein the canonical normalization engine implements an immutable source provenance tracking mechanism that maintains, for each data element in a centralized data store, a complete and unalterable provenance record comprising:
a source identifier identifying the originating data source;
a retrieval method classification identifying whether the data element was obtained via API, optical character recognition, structured file upload, or manual entry;
a retrieval timestamp;
a source authority classification; and
a verification level,
wherein the provenance record for each data element is preserved throughout all downstream processing and is incorporated into the structured verification artifact.

15. The system of claim 13, further comprising a fraud detection module configured to analyze the normalized data object, the weighted composite confidence scores, and the structured discrepancy records to generate a fraud probability score representing an estimated likelihood of fraudulent data in the applicant submission; and
an insurance underwriting module configured to:
receive the fraud probability score from the fraud detection module;
compare the fraud probability score to predefined insurance eligibility thresholds;
when the fraud probability score satisfies the predefined insurance eligibility thresholds, automatically generate an insurance offer comprising a premium value calculated based at least on the fraud probability score; and
upon acceptance of the insurance offer, issue an insurance policy that provides a predetermined payout upon later-verified detection of fraud in the applicant data underlying the insured transaction, thereby replacing or supplementing contractual indemnification obligations between originating parties and downstream purchasers of the transaction.

16. The system of claim 13, wherein the downstream financial decision-making system comprises at least one of:
a mortgage loan underwriting platform,
a commercial lending decisioning system,
a consumer loan origination platform,
an insurance underwriting system,
a credit card approval system,
a financial account opening system, and coupled with an automated risk assessment platform generating an output, wherein such output is deterministic and reproducible for a given set of inputs, and with a complete auditable path justifying the output.
